(19) United States
(12) Patent Application Publication
(10) Pub. No.: US 2006/0228599 A1
(43) Pub. Date: Oct. 12, 2006

(54) Fuel cell unit and method for controlling the same

(75) Inventor: Yuji Takaiwa, Yokohama-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/366,120

(22) Filed: Mar. 2, 2006

(30) Foreign Application Priority Data
Apr. 12, 2005 (JP) P2005-114792

(51) Int. Cl. H01M 8/04

(52) U.S. Cl. 429/22; 429/26; 429/34; 429/13

(57) ABSTRACT

A fuel cell unit includes a mixing tank for producing a fuel/water solution, a fuel cartridge for storing fuel, an EEPROM for storing fuel feed volume information for feeding the fuel to the mixing tank, a fuel supply pump for feeding the fuel from the fuel cartridge to the mixing tank, and temperature sensors/fluid volume sensors/voltage monitors of respective portions connected to the fuel supply pump and for measuring the rotational frequency of the fuel supply pump until the fuel is used up. Fuel feed volume information is calculated newly based on a counted rotational frequency obtained from the measuring result, and the residual quantity of the fuel is calculated from the new fuel feed volume information. The new fuel feed volume information is stored in the EEPROM so as to replace and update the old fuel feed volume information.

### CROSS-REFERENCE TO RELATED APPLICATIONS

This application is based upon and claims the benefit of priority from Japanese Patent Application No. 2005-114792, filed on Apr. 12, 2005, the entire contents of which are incorporated herein by reference.

### BACKGROUND

1. Field

One embodiment of the invention relates to a fuel cell unit which is, for example, of a direct methanol system, and a method for controlling the fuel cell unit.

2. Description of the Related Art

There are various type of fuel cell systems. An example suitable type for an information processing apparatus is a direct methanol fuel cell (DMFC). A cell stack in which a plurality of cells are laminated to one another through separators is applied to such fuel cells. In the cell stack, due to deterioration etc. with use, there may occur an abnormality of a flow rate, pressure, or the like, in a pump feeding a refrigerant for cooling the cell stack. In this event, if power generation is continued, it is likely that the cell stack or the like will be damaged by heat. There may also occur leakage of the refrigerant or the like. It is therefore necessary to design the system to detect an abnormal cell beforehand and prevent a failure from occurring in the system (see JP-A-2002-184435).

In the aforementioned technique, however, abnormality can be detected only about a refrigerant system for cooling the stack. That is, it is impossible to detect abnormality in an air feed pump for feeding the air circulating in a stack air electrode, in a filter for filtering the air, and so on. In addition, it is impossible to make control in consideration of the concentration of the fluid of the refrigerant.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an outline view showing a fuel cell unit according to a first embodiment;

FIG. 2 is an outline view showing a state where an information processing apparatus is connected to the aforementioned fuel cell unit;

FIG. 3 is a system diagram mainly showing the configuration of a power generation portion of the aforementioned fuel cell unit;

FIG. 4 is a system diagram showing a state where the aforementioned information processing apparatus is connected to the aforementioned fuel cell unit;

FIG. 5 is a system diagram showing the configuration of the aforementioned fuel cell unit and the configuration of the aforementioned information processing apparatus;

FIG. 6 is a state transition diagram of the aforementioned fuel cell unit and the aforementioned information processing apparatus;

FIG. 7 is a table showing main control commands for the aforementioned fuel cell unit;

FIG. 8 is a table showing main power supply information of the aforementioned fuel cell unit;

FIG. 9 is a schematic diagram showing abnormal detection ranges of voltage and pressure monitored;

FIG. 10 is a diagram for explaining an example of the configuration of a concentration sensor;

FIG. 11 is a table for explaining determination as to whether to be normal or abnormal in accordance with methanol concentration in a methanol/water solution;

FIG. 12 is a table showing, by classification, kinds of auxiliary units effective in removing bubbles etc. when it is concluded that there has occurred an abnormal state, and processing operations of the auxiliary units;

FIG. 13 is a flow chart showing an operation for a fuel cell control portion to monitor the methanol concentration in the methanol/water solution;

FIG. 14 is a schematic diagram showing a control table set in accordance with a variation with time of solution feed volume information and gas feed information according to a second embodiment; and

FIG. 15 is a schematic diagram showing transition corresponding to a variation with time of the solution feed volume information or the gas feed information, and transition after correction.

### DETAILED DESCRIPTION

Various embodiments according to the invention will be described hereinafter with reference to the accompanying drawings.

### First Embodiment

A first embodiment of the invention will be described below with reference to the drawings.

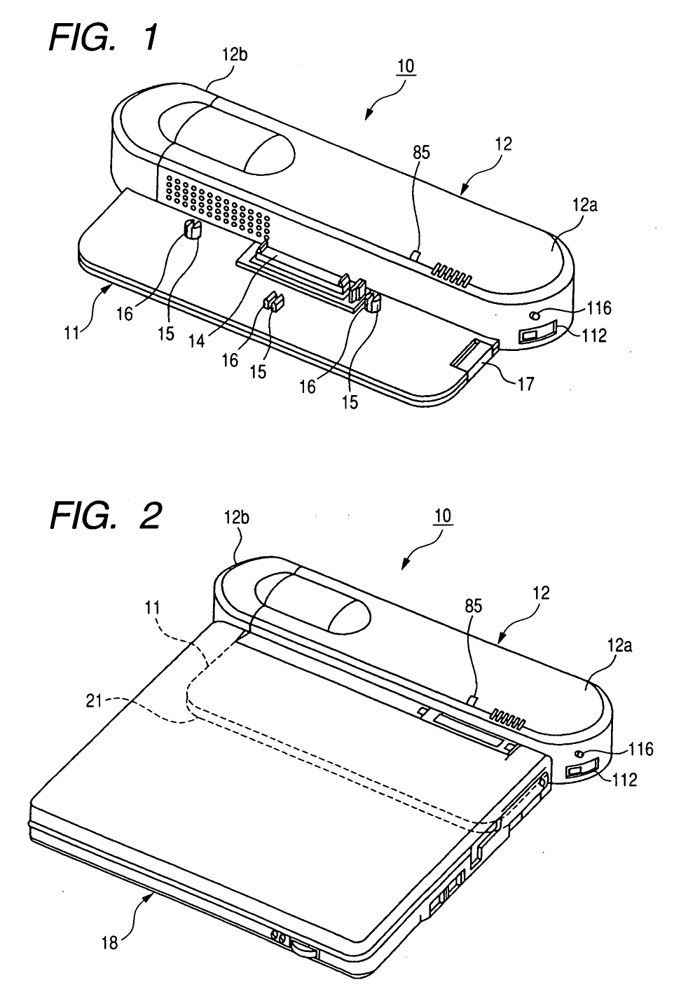

FIG. 1 is an outline view showing a fuel cell unit according to the first embodiment of the invention. As shown in FIG. 1, the fuel cell unit 10 is constituted by a mount portion 11 for mounting a rear portion of an information processing apparatus such as a notebook-sized personal computer, and a fuel cell unit body 12. The fuel cell unit body 12 includes a DMFC stack for generating power by electrochemical reaction, and auxiliary units (pump, valve, etc.) for injecting and circulating methanol serving as fuel, and the air to the DMFC stack.

In addition, a removable fuel cartridge (not shown) is included in the inside, for example, the left end, of a unit casing 12a of the fuel cell unit body 12. A cover 12b can be removed so that this fuel cartridge can be exchanged.

An information processing apparatus is mounted on the mount portion 11. A docking connector 14 serving as a connection portion for securing a connection to the information processing apparatus is provided on the top of the mount portion 11. On the other hand, for example, a bottom rear portion of the information processing apparatus is provided with a docking connector 21 (not shown) serving as a connection portion for securing a connection to the fuel cell unit 10. The docking connector 21 is mechanically and electrically connected to the docking connector 14 of the fuel cell unit 10. In addition, three positioning protrusions 15 and three hooks 16 are provided on the mount portion 11. The positioning protrusions 15 and the hooks 16 are inserted into three holes provided correspondingly in the bottom rear portion of the information processing apparatus.

In order to remove the information processing apparatus from the fuel cell unit 10, an eject button 17 of the fuel cell unit 10 shown in FIG. 2 is pushed. Thus, a lock mechanism (not shown) is released so that the information processing apparatus can be removed easily.

In addition, a power generation setting switch 112 and a fuel cell operation switch 116 are provided, for example, in the right side surface of the fuel cell unit body 12.

The power generation setting switch 112 is a switch by which a user does setting for permitting or prohibiting power generation in the fuel cell unit 10 in advance. The power generation setting switch 112 is, for example, constituted by a sliding switch.

The fuel cell operation switch 116 is used, for example, to suspend only power generation in the fuel cell unit 10 while keeping the information processing apparatus 18 operating when the information processing apparatus 18 is operating by the power generated by the fuel cell unit 10. In this case, the information processing apparatus 18 keeps operating by use of the power of a secondary battery built therein. The fuel cell operation switch 116 is, for example, constituted by a push switch.

An indicator lamp 85 such as an LED (Light-Emitting Diode) is provided, for example, on the top of the fuel cell unit body 12. For example, the indicator lamp 85 is turned on in green when the fuel cell unit body 12 is operative or is turned on in red when the fuel cell unit body 12 is abnormal.

FIG. 2 is a view showing the appearance of the information processing apparatus 18 (e.g. notebook-sized personal computer) mounted on and connected to the mount portion 11 of the fuel cell unit 10.

Incidentally, a number of variations can be considered as the shape or size of the fuel cell unit 10, the shape or position of the docking connector 14, and so on, shown in FIGS. 1 and 2.

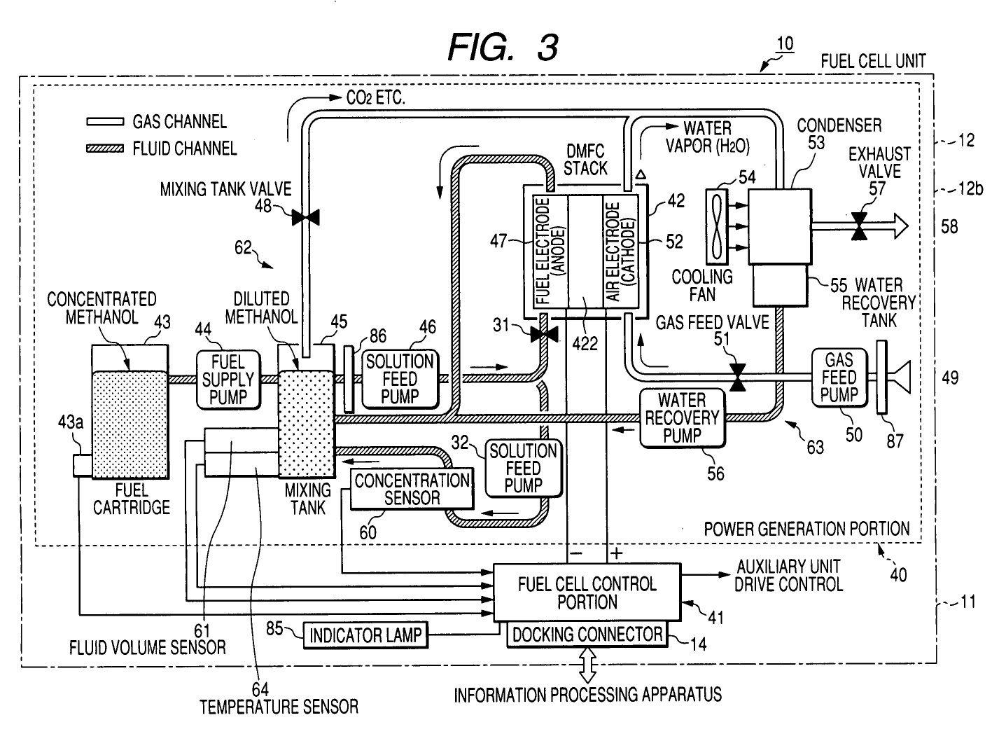

FIG. 3 shows a system diagram of the fuel cell unit 10, and particularly shows a system of details about the DMFC stack and the auxiliary units provided around the DMFC stack.

The fuel cell unit 10 is constituted by a power generation portion 40 and a fuel cell control portion 41 serving as a control portion of the fuel cell unit 10. The fuel cell control portion 41 has a function as a communication control portion for communicating with the information processing apparatus 18 as well as a function of controlling the power generation portion 40.

The power generation portion 40 includes a fuel cartridge 43 serving as a fuel reservoir unit for storing methanol serving as fuel, as well as a DMFC stack 42 playing a central role in power generation. The fuel cartridge 43 is filled with concentrated methanol. The fuel cartridge 43 is removably attached so that the fuel cartridge 43 can be exchanged easily when the fuel has been consumed.

It is generally necessary to reduce a crossover phenomenon in direct methanol type fuel cells in order to increase the efficiency of power generation. To this end, it is effective to dilute concentrated methanol and inject this diluted methanol into a fuel electrode 47. In order to realize this, in the fuel cell unit 10, a diluting/circulating system 62 is used. Auxiliary units 63 required for realizing the diluting/circulating system 62 are provided in the power generation portion 40.

Some auxiliary units 63 are provided in a fluid channel, and the other auxiliary units 63 are provided in a gas channel.

In the fluid channel, a fuel supply pump 44 serving as a fuel supply unit is connected to a duct from an output portion of the fuel cell cartridge 43, and an output portion of the fuel supply pump 44 is connected to a mixing tank 45. Further, an output portion of the mixing tank 45 is connected to a solution feed pump 46 through a solution feed filter 86, and an output portion of the solution feed pump 46 is connected to the fuel electrode 47 of the DMFC stack 42 through a solution feed valve 31. Further, an output portion of the fuel electrode 47 is connected to the mixing tank 45 by piping. The fluid channel in which fluid flows thus back to the mixing tank 45 by the power of the solution feed pump 46 will be referred to as “first fluid channel”. The solution pump 46 may be provided not on the input side of the fuel electrode 47 but on the output side of the fuel electrode 47. In addition, the solution feed valve 31 is not always required.

An output portion of a water recovery tank 55 is connected to a water recovery pump 56 by piping, and an output portion of the water recovery pump 56 is connected to the mixing tank 45.

A branch is provided between the solution feed pump 46 and the fuel electrode 47 in the first fluid channel. Another channel (pipe or the like) allowing the methanol/water solution to flow back to the mixing tank 45 via this branch is provided. This channel will be referred to as “second fluid channel”. The second fluid channel is a dedicated channel provided for detecting the methanol concentration in the methanol/water solution. A solution feed pump 32 is provided in the second fluid channel, and an output portion of the solution feed pump 32 is connected to the mixing tank 45 through a concentration sensor 60. Incidentally, the solution feed pump 32 is not always required.

The concentration sensor 60 is attached to a channel portion where the methanol/water solution (whose temperature reaches 60° C. or higher) flowing from the first fluid channel to the second fluid channel has been cooled so that the temperature thereof has reached, for example, 40° C. or lower. Thus, the concentration sensor 60 can be prevented from being adversely affected by heat.

The amount of a methanol/water solution necessary for the concentration sensor 60 to detect the concentration is slight (negligible as compared with the total amount of the methanol/water solution used in the power generation portion 40). That is, the inner diameter of the second fluid channel is much smaller than the inner diameter of the first fluid channel so that the amount of the methanol/water solution flowing into the second fluid channel is significantly slight. Thus, adversely effect on fuel supply to the DMFC stack 42 can be prevented.

On the other hand, in the gas channel, a gas feed pump 50 is connected to an air electrode 52 of the DMFC stack 42 through a gas feed valve 51. An output portion of the air electrode 52 is connected to a condenser 53. The mixing tank 45 is also connected to the condenser 53 through a mixing tank valve 48. The condenser 53 is connected to an exhaust opening 58 through an exhaust valve 57. The condenser 53 is provided with a fin for effectively condensing water vapor. In addition, a cooling fan 54 is disposed near the condenser 53.

Next, the power generation mechanism of the power generation portion 40 of the fuel cell unit 10 will be described along the flows of the fuel and the air (oxygen).

First, concentrated methanol in the fuel cartridge 43 flows into the mixing tank 45 by means of the fuel supply pump 44. The concentrated methanol is mixed and diluted with recovered water, diluted methanol (residual after power generation reaction) from the fuel electrode 47, etc. in the mixing tank 45 so as to produce diluted methanol. The concentration of the diluted methanol is controlled to keep concentration high in power generation efficiency (e.g. 3%-6%). This concentration control is attained by the fuel cell control portion 41 which controls the amount of the concentrated methanol supplied to the mixing tank 45 by the fuel supply pump 44, for example, based on a detection result of the concentration sensor 60. Alternatively, the concentration control may be attained by the water recovery pump 56 or the like controlling the amount of water flowing back to the mixing tank 45.

The mixing tank 45 is also provided with a fluid volume sensor 61 for detecting the volume of the methanol/water solution in the mixing tank 45, and a temperature sensor 64 for detecting the temperature. Further, the fuel cartridge 43 is also provided with a fluid volume sensor 43a. The detection results of these sensors are sent to the fuel cell control portion 41 so as to be used for controlling the power generation portion 40 and so on.

The methanol/water solution diluted in the mixing tank 45 is pressurized by the solution feed pump 46, and injected into the fuel electrode (anode) 47 of the DMFC stack 42. In the fuel electrode 47, electrons are generated by oxidation reaction of methanol. Hydrogen ions (H+) generated by the oxidation reaction penetrate a solid polymer electrolyte membrane 422 in the DMFC stack 42 and reach the air electrode (cathode) 52.

On the other hand, carbon dioxide generated by the oxidation reaction performed in the fuel electrode 47 flows back to the mixed tank 45 together with the methanol/water solution that was not used for reaction. The carbon dioxide vaporizes in the mixing tank 45 and approaches the condenser 53 through the mixing tank valve 48. Finally, the carbon dioxide is discharged from the exhaust opening 58 to the outside through the exhaust valve 57.

On the other hand, as for the flow of the air (oxygen), the air is sucked from an air intake 49 and filtered by an air feed filter 87. After that, the air is pressurized by the air feed pump 50 and injected into the air electrode (cathode) 52 through the air feed valve 51. In the air electrode 52, reduction reaction of oxygen (O₂) makes progress so that water (H₂O) is produced as water vapor out of electrons (e⁻) from an external load, hydrogen ions (H⁺) from the fuel electrode 47 and the oxygen (O₂). This water vapor is discharged from the air electrode 52 and put into the condenser 53. In the condenser 53, the water vapor is cooled by the cooling fan 54 so as to be formed into water (liquid). The water is temporarily accumulated in the water recovery tank 55. The recovered water flows back to the mixed tank 45 by means of the water recovery pump 56. Thus, the diluting/circulating system 62 for diluting the concentrated methanol is arranged.

As is understood from the power generation mechanism of the fuel cell unit 10 using the diluting/circulating system 62, the auxiliary units 63 including the pumps 44, 46, 50 and 56, the valves 48, 51 and 57, the cooling fan 54, etc. in the respective portions are driven to extract power from the DMFC stack 42, that is, to start power generation. Thus, the methanol/water solution and the air (oxygen) are injected into the DMFC stack 42 so that power can be obtained with the progress of electrochemical reaction. On the contrary, in order to suspend the power generation, driving these auxiliary units 63 is suspended.

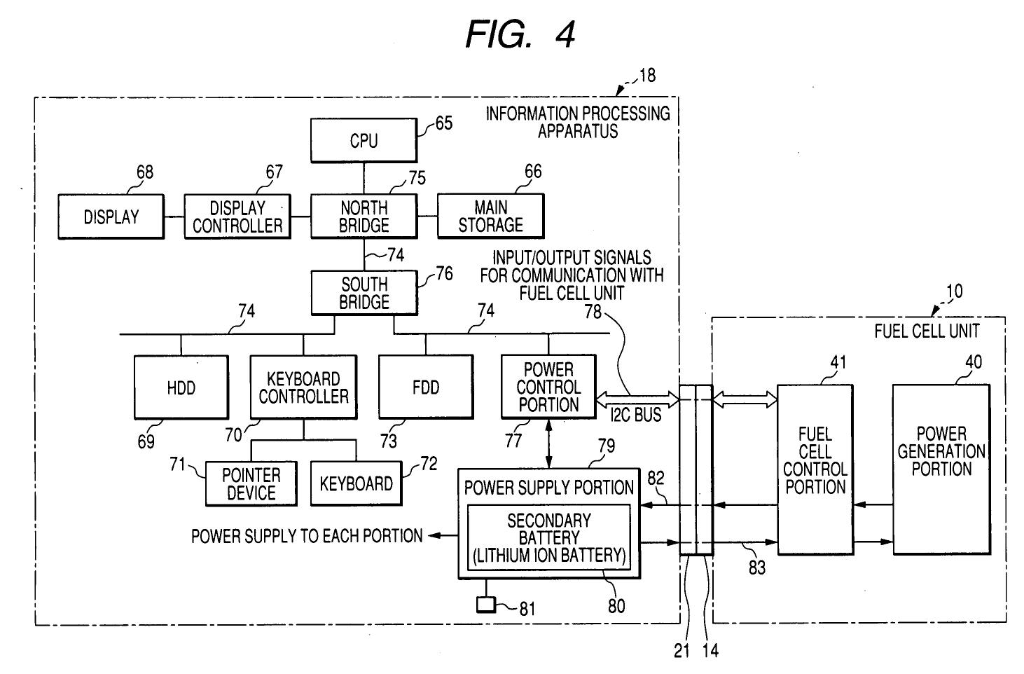

FIG. 4 shows a system configuration of the information processing apparatus 18 to which the fuel cell unit 10 according to the present invention is connected.

The information processing apparatus 18 is constituted by a CPU 65, a main storage 66, a display controller 67, a display 68, an HDD (Hard Disk Drive) 69, a keyboard controller 70, a pointer device 71, a keyboard 72, an FDD 73, a bus 74 for transferring signals among these constituents, devices called a north bridge 75 and a south bridge 76 for converting signals to be transferred via the bus 74, etc. In addition, a power supply portion 79 is provided inside the information processing apparatus 18. For example, the power supply portion 79 includes a lithium-ion battery as a secondary battery 80. The power supply portion 79 is controlled by a control portion (hereinafter referred to as “power control portion 77”).

A control system interface and a power supply system interface are provided as electric interfaces between the fuel cell unit 10 and the information processing apparatus 18. The control system interface is an interface provided for making communication between the power control portion 77 of the information processing apparatus 18 and the control portion 41 of the fuel cell unit 10. Communication made between the information processing apparatus 18 and the fuel cell unit 10 via the control system interface is performed through a serial bus such as an I2C bus 78.

The power supply system interface is an interface provided for giving and receiving power between the fuel cell unit 10 and the information processing apparatus 18. For example, power generated in the DMFC stack of the power generation portion 40 is supplied to the information processing apparatus 18 through the control portion 41 (hereinafter referred to as “fuel cell control portion 41”) and the docking connectors 14 and 21. In addition, the power supply system interface includes a power supply 83 from the power supply portion 79 of the information processing apparatus 18 to the auxiliary units 63 and so on in the fuel cell unit 10.

DC power converted from AC to DC is supplied to the power supply portion 79 of the information processing apparatus 18 through an AC adapter connector 81. By the DC power, the information processing apparatus 18 can be operated and the secondary battery (lithium-ion battery) 80 can be charged.

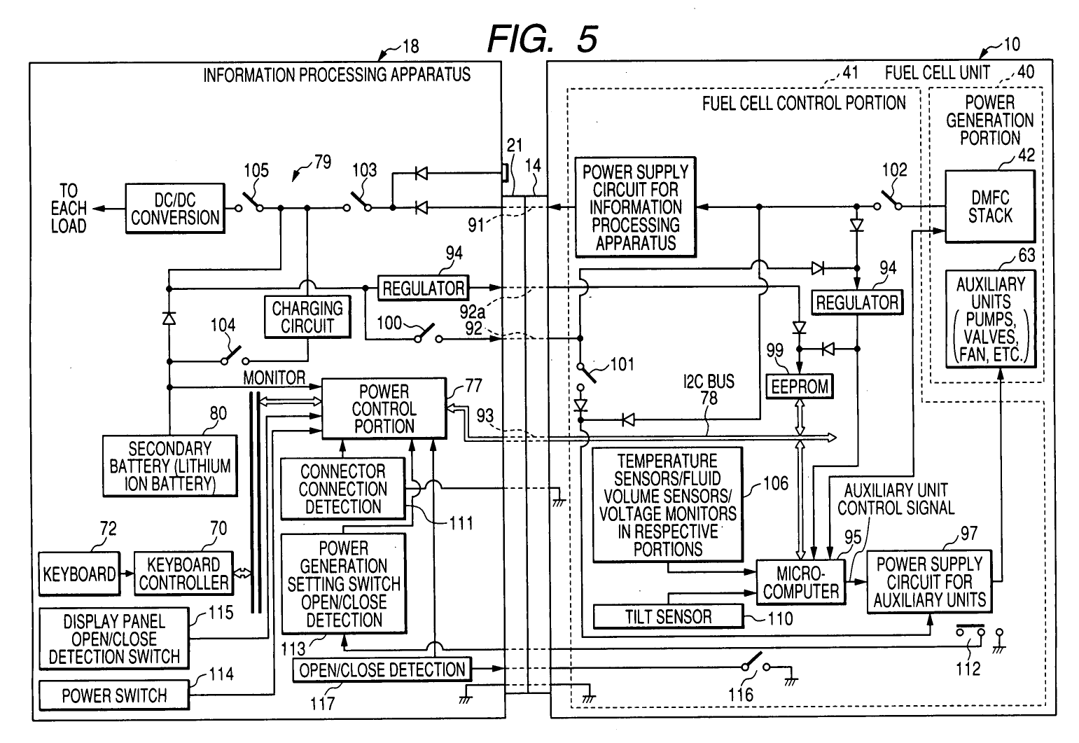

FIG. 5 shows a configuration example showing a connection relation between the fuel cell control portion 41 of the fuel cell unit 10 and the power supply portion 79 of the information processing apparatus 18.

The fuel cell unit 10 and the information processing apparatus 18 are mechanically and electrically connected through the docking connectors 14 and 21. Each docking connector 14, 21 has a first power supply terminal (output power supply terminal) 91 and a second power supply terminal (input power supply terminal for the auxiliary units) 92. The first power supply terminal 91 serves to supply the power generated by the DMFC stack 42 of the fuel cell unit 10 to the information processing apparatus 18. The second power supply terminal 92 serves to supply power to a microcomputer 95 of the fuel cell unit 10 through a regulator 94 and supply power to a power supply circuit 97 for the auxiliary units through a switch 101. In addition, each docking connector 14, 21 has a third power supply terminal 92a serving to supply power from the information processing apparatus 18 to a nonvolatile memory (EEPROM) 99.

Further, each docking connector 14, 21 has a communication input/output terminal 93 for making communication between the power control portion 77 of the information processing apparatus 18 and the microcomputer 95 or the writable EEPROM 99 of the fuel cell unit 10.

The fuel cell control portion 41 has a tilt sensor 110 and temperature sensors/fluid volume sensors/voltage monitors 106 of respective portions. The tilt sensor 110 detects a tilt of the fuel cell unit body 12 and sends a detection signal to the microcomputer 95. Each temperature sensor/fluid volume sensor/voltage monitor 106 detects a voltage, a rotational frequency and a solution feed time of the solution feed pump 46 or the gas feed pump 50, a temperature of each portion, a fluid volume, a concentration of the fuel/water solution based on the concentration sensor 60, etc., and sends a detection signal to the microcomputer 95.

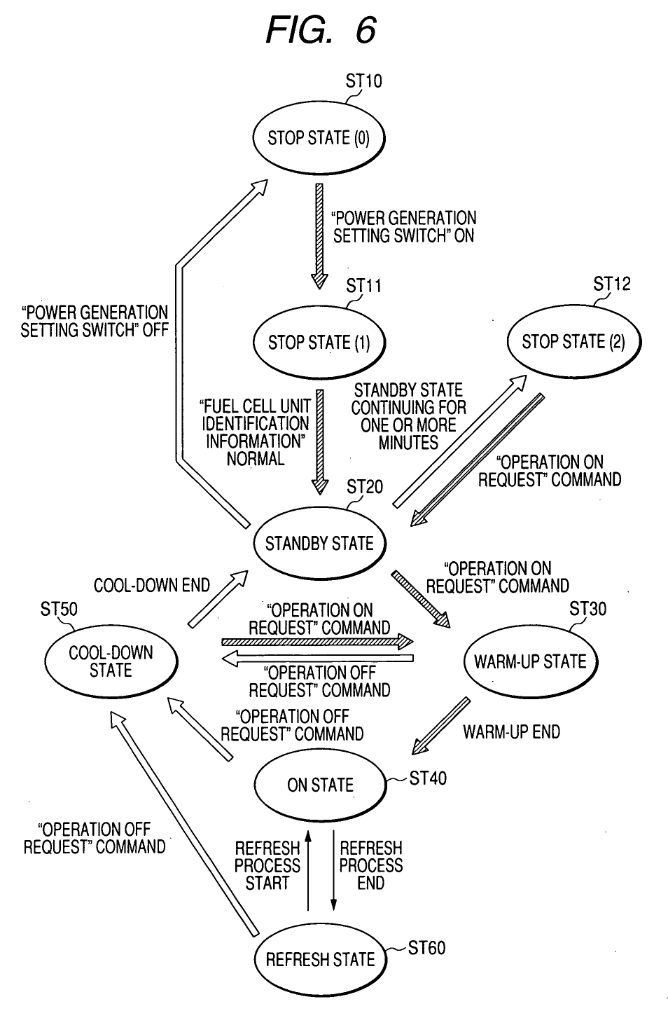

Next, a fundamental flow of processing till the power of the DMFC stack 42 provided in the fuel cell unit 10 is supplied from the fuel cell unit 10 to the information processing apparatus 18 will be described with reference to the connection diagram shown in FIG. 5 and the state transition diagram of the fuel cell unit 10 shown in FIG. 6.

Assume that predetermined power has been charged into the secondary battery (lithium-ion battery) 80 of the information processing apparatus 18. In addition, assume that all the switches in FIG. 5 are open.

First, based on a signal output from a connector connection detection portion 111, the information processing apparatus 18 recognizes that the information processing apparatus 18 and the fuel cell unit 10 have been mechanically and electrically connected. This recognition is obtained by detecting that the connector connection detection portion 111 is grounded inside the fuel cell unit 10 due to the connection between the docking connectors 14 and 21, for example, based on a signal input to the connector connection detection portion 111.

The power control portion 77 of the information processing apparatus 18 recognizes whether the power generation setting switch 112 of the fuel cell unit 10 has been set as permission for power generation or prohibition of power generation. For example, based on a signal input to a power generation setting switch detection portion 113, the power generation setting switch detection portion 113 detects whether the power generation setting switch 112 is in a grounded state or in a released state in accordance with the setting state of the power generation setting switch 112. When the power generation setting switch 112 is in the released state, the power control portion 77 recognizes the setting of the power generation setting switch 112 as prohibition of power generation.

The state where the power generation setting switch 112 is set as prohibition of power generation is a state corresponding to “Stop State (0)” ST10 in the state transition diagram of FIG. 6.

When the information processing apparatus 18 and the fuel cell unit 10 are mechanically connected through the docking connectors 14 and 21, power is supplied from the information processing apparatus 18 side through a third power supply terminal 92a to the nonvolatile memory (EEPROM) 99 serving as a storage portion of the fuel cell control portion 41. The EEPROM 99 beforehand stores identification information of the fuel cell unit 10, fuel feed volume information (initial values of the rotational frequency, the voltage, etc. of the fuel supply pump 44), fuel/water solution feed volume information (initial values of the rotational frequency, the voltage, etc. of the solution feed pump 46), an initial value of concentration information of the methanol/water solution, an allowable value (predetermined constant value) of a deviation from the initial value, gas feed information (initial values of the rotational frequency, the voltage, etc. of the gas feed pump 50), etc. The identification information of the fuel cell unit 10 may include information such as a part code, a manufacturing serial number, a rated output, tank capacity information of the fuel cartridge 43, etc. in advance. The EEPROM 99 is connected to a serial bus such as the I2C bus 78. Data stored in the EEPROM 99 can be read only when power is being supplied to the EEPROM 99. In the configuration of FIG. 5, the power control portion 77 can read information from the EEPROM 99 through the communication input/output terminal 93.

In this state, the fuel cell unit 10 has not generated power. As for the internal state of the fuel cell unit 10, no power but the power for the EEPROM 99 has been supplied. In this state, the indicator lamp 85 is off.

Here, when the user sets the power generation setting switch 112 as permission for power generation (the power generation setting switch is set to the grounded state side in FIG. 5), the power control portion 77 provided in the information processing apparatus 18 can read the identification information stored in the EEPROM 99 provided in the fuel cell unit 10. This state is a state of “Stop State (1)” ST11 in FIG. 6.

In other words, as long as the user does not set the power generation setting switch 112 as permission for power generation, that is, as long as the power generation setting switch 112 is set as prohibition of power generation, the fuel cell unit 10 is in “Stop State (0)” ST10. Accordingly, the user can prohibit power generation in the fuel cell unit 10.

It is preferable that the power generation setting switch can be held in either the open state or the close state, for example, like a sliding switch.

The identification information is read by the power control portion 77 as follows. That is, the identification information of the fuel cell unit 10 stored in the EEPROM 99 provided in the fuel cell unit 10 is read through a serial bus such as the I2C bus 78.

After the aforementioned processing, the fuel cell unit 10 undergoes a transition from “Stop State (1)” ST11 to “Standby State” ST20.

Specifically, the power control portion 77 provided in the information processing apparatus 18 closes a switch 100 provided in the information processing apparatus 18 so as to supply the power of the secondary battery 80 to the fuel cell unit 10 through the first power supply terminal 92. Thus, the power is supplied to the microcomputer 95 through the regulator 94.

In this state of “Standby State” ST20, the switch 101 provided in the fuel cell unit 10 is open. Thus, no power is supplied to the power supply circuit 97 for the auxiliary units. Therefore, no auxiliary units 63 are operating in this state.

However, the microcomputer 95 has begun to operate so that the microcomputer 95 can receive various control commands through the I2C bus 78 from the power control portion 77 provided in the information processing apparatus 18. In addition, the microcomputer 95 can transmit the power supply information of the fuel cell unit 10 to the information processing apparatus 18 through the I2C bus. In this state, for example, the indicator lamp 85 is turned on in green, indicating normal operation. Alternatively, the indicator lamp 85 may be turned on in another state, for example, as soon as power generation starts in the fuel cell unit 10 as will be described later (Warm-up State ST30) or as soon as the output reaches a rated value (On State ST40).

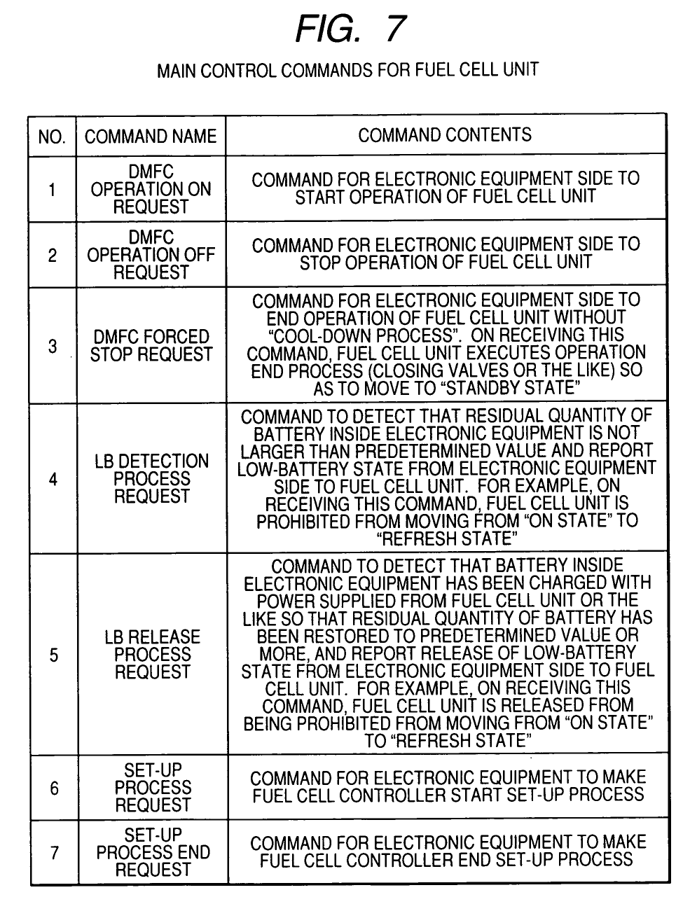

FIG. 7 is a table showing control commands to be sent from the power control portion 77 provided in the information processing apparatus 18 to the microcomputer 95 provided in the fuel cell control portion 41, by way of example.

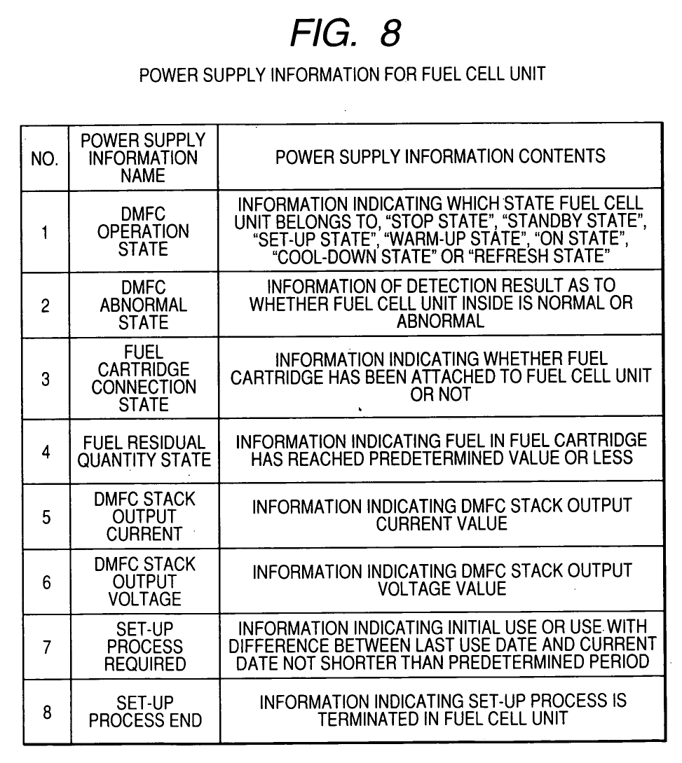

FIG. 8 is a table showing power supply information to be sent from the microcomputer 95 provided in the fuel cell control portion 41 to the power control portion 77 provided in the information processing apparatus 18, by way of example.

The power control portion 77 provided in the information processing apparatus 18 reads “DMFC Operating State” (No. 1 in FIG. 8) of the power supply information in FIG. 8. Thus, the power control portion 77 recognizes that the fuel cell unit 10 is in “Standby State” ST20.

When the power control portion 77 sends a “DMFC operation ON request” command (power generation start command) of the control commands shown in FIG. 7, to the fuel cell control portion 41 in this state of “Standby State” ST20, the fuel cell control portion 41 receiving the “DMFC operation ON request” command brings the state of the fuel cell unit 10 into “Warm-up State” ST30.

Specifically, the switch 101 provided in the fuel cell control portion 41 is closed under the control of the microcomputer 95, so as to supply the power from the information processing apparatus 18 to the power supply circuit 97 for the auxiliary units. In addition, the auxiliary units 63 provided in the power generation portion 40, that is, the pumps 44, 46, 50 and 56, the valves 48, 51 and 57, the cooling fan 54, etc. shown in FIG. 4 are driven by control signals for the auxiliary units transmitted from the microcomputer 95 respectively. Further, the microcomputer 95 closes the switch 102 provided in the fuel cell control portion 41.

As a result, the methanol/water solution and the air are injected into the DMFC stack 42 provided in the power generation portion 40. Thus, power generation is started. In addition, the power generated by the DMFC stack 42 begins to be supplied to the information processing apparatus 18. However, the generated output power does not reach a rated value immediately. The state till the output power reaches the rated value is therefore referred to as “Warm-up State” ST30.

When the fuel cell unit 10 transits to the state of “Warm-up State” ST30, the microcomputer 95 starts a process to monitor a voltage, a rotational frequency or a solution feed time of the solution feed pump 46 or the gas feed pump 50, a temperature of each portion, a fluid volume, a concentration of the fuel/water solution based on the concentration sensor 60, etc. based on information from each temperature sensor/fluid volume sensor/voltage monitor 106 in each portion, and send monitored information to the microcomputer 95.

FIG. 9 is a schematic diagram showing an abnormality detection range corresponding to the monitored information. For example, the microcomputer 95 detects abnormality based on the voltages and pressures of the solution feed pump 46 and the gas feed pump 50, which are supply operation quantities sent from the temperature sensors/fluid volume sensors/voltage monitors 106 in the respective portions.

As shown in FIG. 9, a graph is created with the ordinate designating the voltage and the abscissa designating the pressure. V1 designates an initial value of the voltage stored in the EEPROM 99. A range within a constant value from the initial value V1 is set as a normal operation range. That is, a maximum value Vmax and a minimum value Vmin are set as values of the normal operation range. Thus, when a voltage is higher than the initial value V1 by a constant value (Vmax-V1) or more, the voltage is regarded as abnormal. Further, when a voltage is lower than the initial value V1 by a constant value (V1-Vmin) or more, the voltage is regarded as abnormal. For example, a voltage V2 (pressure P2) in FIG. 9 is within the range between Vmax and V1, the voltage V2 is regarded as a normal operation region.

When the voltage is regarded as abnormal, the following process (1) is performed. When the voltage is not restored, the following process (2) is performed.

(1) The voltage or the like showing an abnormal value is controlled to be in a normal operation region. For example, when the voltage is lower than Vmin, an instruction to increase the voltage is given to the solution feed pump 46 or the gas feed pump 50 from the fuel cell control portion 41 so as to increase the voltage to Vmin or higher.

(2) The indicator lamp 85 is turned on in a color indicating abnormality, for example, in red. Further, in accordance with necessity, a display corresponding to the indicator lamp 85, for example, a message indicating normal operation or abnormal stop is displayed on a display unit such as a display provided in the information processing apparatus 18. When the voltage drops due to clogging of the filter or the like, a display (blinking of the indicator lamp 85 or the like) to urge the user to exchange the filter for a new one may be performed.

The aforementioned processes may be performed in accordance with the operation of monitoring the methanol concentration in the methanol/water solution, which operation will be described later.

In the state of “Warm-up State” ST30, the microcomputer 95 provided in the fuel cell control portion 41 monitors, for example, the output voltage of the DMFC stack 42 and the temperature of the DMFC stack 42. When the microcomputer 95 concludes that the output of the DMFC stack 42 has reached a rated value, the microcomputer 95 opens the switch 101 provided in the fuel cell unit 10 so that the power supply source to the auxiliary units 63 is switched from the information processing apparatus 18 to the DMFC stack 42. This state is “On State” ST40.

The outline of the flow of processing from “Stop State” ST10 to “On state” ST40 has been described.

Description will be made below on the aforementioned concentration sensor 60 with reference to FIG. 3 and FIGS. 10-12.

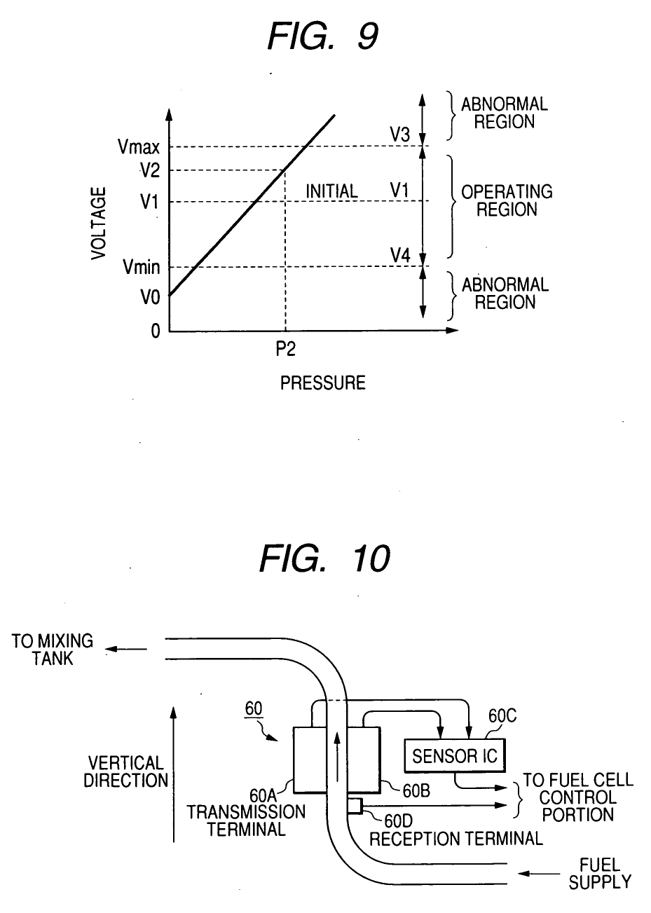

FIG. 10 is a diagram for explaining an example of the configuration of the concentration sensor 60.

The concentration sensor 60 is installed in the aforementioned second fluid channel (fluid channel where the methanol/water solution fed from the solution feed pump 46 branches from the first fluid channel and flows back to the mixing tank 45). In this case, the concentration sensor 60 is attached to a channel portion of the second channel where the methanol/water solution flows against the gravity, that is, the methanol/water solution flows from the bottom to the top (for example, vertically). In such a channel portion, bubbles etc. smaller in specific gravity than the methanol/water solution escape upward easily so that the probability that the bubbles etc. will stay on the way of the channel is low. Even when the bubbles etc. stay, the staying bubbles etc. can be let out upward easily if the flow of the methanol/water solution is changed by control as will be described later.

The concentration sensor 60 is attached to a channel portion where the methanol/water solution flowing from the first fluid channel to the second fluid channel (the temperature of the methanol/water solution has reached 60° C. or higher) is cooled so that the temperature thereof is, for example, 40° C. or lower. Consequently, the concentration sensor 60 can be prevented from being adversely affected by heat.

For example, a so-called sound velocity sensor can be applied to the concentration sensor 60. The concentration sensor 60 is not limited to the sound velocity sensor. Any other kind of sensor may be applied to the concentration sensor 60 if it can finally measure the methanol concentration. When a sound velocity sensor is used, the concentration sensor 60 has, for example, a transmission terminal 60A, a reception terminal 60B, a sensor IC 60C and a temperature sensor (thermistor) 60D. The aforementioned channel portion is designed to be located between the transmission terminal 60A and the reception terminal 60B.

The transmission terminal 60A transmits a given pulse to the reception terminal 60B periodically. The reception terminal 60B receives the pulse transmitted from the transmission terminal 60A. Based on a difference between the timing with which the pulse is transmitted from the transmission terminal 60A and the timing with which the pulse is received by the reception terminal 60B, the sensor IC 60C detects the sound velocity with which the pulse passes through the methanol/water solution in the aforementioned channel portion. There is a tendency that the sound velocity becomes low when the methanol concentration is high, and the sound velocity becomes high when the methanol concentration is low. The fuel cell control portion 41 is notified of the detection result in the sensor IC 60C. On the other hand, the temperature sensor 60D detects the temperature of the methanol/water solution flowing in the aforementioned channel portion. It has been known that the concentration of methanol in a methanol/water solution changes in accordance with the temperature of the methanol/water solution. Therefore, the temperature detected by the temperature sensor 60D is also used for measuring the methanol concentration. The fuel cell control portion 41 is notified of the measuring result in the temperature sensor 60D.

The fuel cell control portion 41 obtains the methanol concentration in the methanol/water solution based on the measuring results in the sensor IC 60C and the temperature sensor 60D. Specifically, the fuel cell control portion 41 obtains the methanol concentration from the measured sound velocity based on the correlation between the methanol concentration and the sound velocity. Further, the obtained methanol concentration value is corrected in accordance with the temperature measured by the temperature sensor 60D. Such final calculation of the methanol concentration may be performed inside the sensor IC 60C.

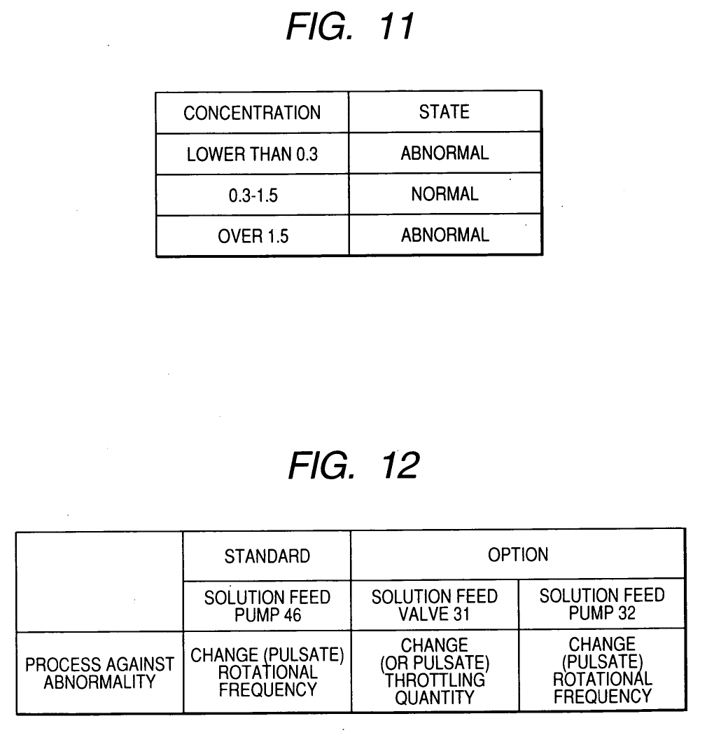

The fuel cell control portion 41 determines whether the state is “abnormal” or “normal” in accordance with whether the methanol concentration obtained thus deviates from a predetermined concentration range (or remains unchanged) continuously for a definite time or not. For example, when the methanol concentration deviates from a range, for example, from 0.3 to 1.5 [mol/l] continuously for a definite time (or the value of the methanol concentration remains unchanged continuously for a definite time) as shown in FIG. 11, the fuel cell control portion 41 concludes that there may have occurred such an abnormal state that bubbles or dust stays in the channel portion where the concentration sensor 60 is installed. On the contrary, when the methanol concentration is not in such a state but within the range of from 0.3 to 1.5 [mol/l], the fuel cell control portion 41 concludes that the state is normal.

When the fuel cell control portion 41 concludes that there has occurred “abnormality” as described above, the fuel cell control portion 41 controls the auxiliary units 63 so as to change the flow of the methanol/water solution in the second fluid channel. As a result, there also occurs a change in the flow of the methanol/water solution in the channel portion where the concentration sensor 60 is attached. Thus, the staying bubbles etc. are shaken so that the bubbles etc. are expected to be removed from the channel portion.

FIG. 12 is a table showing, by classification, kinds of auxiliary units effective in removing bubbles etc. when it is concluded that there has occurred an abnormal state, and processing operations of the auxiliary units.

The solution feed pump 46 provided in the first fluid channel is an auxiliary unit required for supplying the methanol/water solution to the fuel electrode 47 of the DMFC stack 42. Therefore, the solution feed pump 46 is provided in the standard specification. When the rotational frequency of the solution feed pump 46 is changed or increased/decreased periodically (that is, pulsated), there occurs a change in the flow of the methanol/water solution in the channel portion where the concentration sensor 60 is attached. Thus, pulsating the rotational frequency is effective in removing bubbles etc. staying in the channel portion.

The solution feed valve 31 provided in the first fluid channel is provided optionally. The solution feed valve 31 is not always required. However, in the case where the solution feed valve 31 is provided, and when the throttling quantity of the solution feed valve 31 is changed or increased/decreased periodically (that is, pulsated), there occurs a change in the flow of the methanol/water solution in the channel portion where the concentration sensor 60 is attached. Thus, pulsating the throttling quantity is effective in removing bubbles etc. staying in the channel portion.

The solution feed pump 32 provided in the second fluid channel is provided optionally. The solution feed pump 32 is not always required. However, in the case where the solution feed pump 32 is provided, and when the rotational frequency of the solution feed pump 32 is changed or increased/decreased periodically (that is, pulsated), there occurs a change in the flow of the methanol/water solution in the channel portion where the concentration sensor 60 is attached. Thus, pulsating the rotational frequency is effective in removing bubbles etc. staying in the channel portion.

Bubbles etc. can be reduced if one of the rotational frequency of the solution feed pump 46, the throttling quantity of the solution feed valve 31 and the rotational frequency of the solution feed pump 32 is changed (or pulsated). However, the change (or pulsation) of the rotational frequency of the solution feed pump 46 and the change (or pulsation) of the throttling quantity of the solution feed valve 31 may be performed together, or the change (or pulsation) of the rotational frequency of the solution feed pump 46 and the change (or pulsation) of the rotational frequency of the solution feed pump 32 may be performed together. In this case, it is possible surely change the flow of the methanol/water solution in the channel portion where the concentration sensor 60 is attached, so that bubbles etc. staying in the channel portion can be removed effectively.

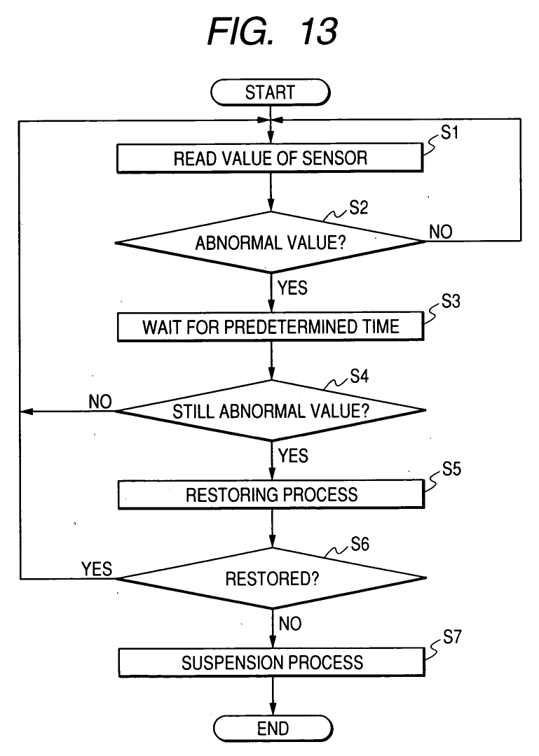

Next, with reference to FIG. 13, description will be made on the operation in which the fuel cell control portion 41 monitors the methanol concentration in the methanol/water solution.

Now, the fuel cell unit 10 is in the state of “On State” ST40 (see FIG. 6) in which the DMFC stack 42 is engaged in a normal power generation operation.

The fuel cell control portion 41 reads the detection result of the concentration sensor 60 so as to obtain the methanol concentration in the methanol/water solution (Step S1). Then, the fuel cell control portion 41 determines whether the obtained methanol concentration deviates from a predetermined concentration range or not (Step S2).

Here, when the obtained methanol concentration is within the predetermined concentration range, the routine of processing returns to Step S1, where the same processing is repeated. On the contrary, when the obtained methanol concentration shows an abnormal value deviating from the predetermined concentration range, the fuel cell control portion 41 waits for a predetermined time to pass (Step S3).

When the predetermined time has passed, the fuel cell control portion 41 determines whether the methanol concentration remains an abnormal value or not (Step S4). When the methanol concentration is within the predetermined concentration range, the fuel cell control portion 41 repeats the processing from Step S1. On the other hand, when the methanol concentration remains an abnormal value, the fuel cell control portion 41 considers that it is likely that there has occurred such an abnormal state where bubbles or dust stays in the channel portion provided in the concentration sensor 60. Thus, the fuel cell control portion 41 concludes that it is necessary to perform a restoring process for restoring the state to the normal state.

Even when the obtained methanol concentration is within the predetermined concentration range, and if the methanol concentration remains an abnormal value continuously for a definite time, the fuel cell control portion 41 considers that there has occurred an abnormal state. Thus, the fuel cell control portion 41 concludes that it is necessary to perform a restoring process for restoring the state to the normal state.

When the fuel cell control portion 41 concludes that the restoring process is required, the fuel cell control portion 41 carries out the restoring process (Step S5). In the restoring process, the fuel cell control portion 41 changes (or pulsates) one of the rotational frequency of the solution feed pump 46, the throttling quantity of the solution feed valve 31 and the rotational frequency of the solution feed pump 32 or a combination of these so as to change the flow of the methanol/water solution in the channel portion where the concentration sensor 60 is attached.

After carrying out the restoring process, the fuel cell control portion 41 determines whether the methanol concentration is restored to its normal state within the predetermined concentration range or not (Step S6). When the methanol concentration is restored to the normal state, the processing from Step S1 is repeated. On the contrary, when the methanol concentration is not restored to the normal state, the fuel cell control portion 41 suspends the operation of the power generation portion (power generation system) 40 (Step S7).

The concentration information detected by the concentration sensor 60 and the supply operation quantities such as the supply powers, pressures, etc. of the solution feed pump 46 and the gas feed pump 50 can be obtained from the aforementioned temperature sensors/fluid volume sensors/voltage monitors 106 of respective portions. These pieces of information may be dealt with comprehensively. That is, when one or more values of these pieces of information (or given values, for example, concentration, voltage, etc.) are abnormal values, the processing shown in FIG. 13 maybe performed so that control or suspension can be performed by the fuel cell control portion 41.

In such a manner, according to this embodiment, not only the state of the solution feed pump 46 but also the state of the gas feed pump 50, the state of the concentration of the methanol/water solution, etc. are monitored so that the abnormality of the fuel cell unit can be detected comprehensively.

Whenever the fuel cartridge 43 is exchanged for a new one, a fuel feed volume is corrected to thereby set an optimal fuel feed volume. Therefore, it is possible to cope with variation in individual fuel supply pumps, lowering in fuel feed volume of a fuel supply pump due to deterioration, variation in internal pressure of the operative mixing tank due to capacity of a fuel supply pump, variation in fuel consumption volume, change in internal pressure of the fuel cartridge, etc. At the time same, it is possible to detect the residual quantity of fuel correctly without trouble based on the optimal fuel feed volume.

In addition, when the fuel concentration obtained from the detection result of the concentration sensor 60 shows an abnormal state, one of the rotational frequency of the solution feed pump 46, the throttling quantity of the solution feed valve 31 and the rotational frequency of the solution feed pump 32 or a combination of these are changed (or pulsated) so that the flow of the methanol/water solution in the channel portion where the concentration sensor 60 is attached can be changed surely. Accordingly, bubbles etc. staying in the channel portion can be removed effectively. When the abnormal state lasts in spite of execution of the restoring process, the power generation portion 40 is suspended. Accordingly, danger can be avoided.

In addition, the concentration sensor 60 is attached to a channel portion where the methanol/water solution flows against gravity. Accordingly, the probability that something stays on the way of the channel is low. There is another advantage that bubbles etc. can be escaped upward easily by controlling the auxiliary units to thereby change the flow of the solution even if the bubbles etc. stay in the channel.

In addition, the concentration sensor 60 is attached to a channel portion where the methanol/water solution (whose temperature reaches 60° C. or higher) flowing from the first fluid channel to the second fluid channel has been cooled so that the temperature thereof has reached 40° C. or lower. Thus, the concentration sensor 60 can be prevented from being adversely affected by heat.

The amount of the methanol/water solution necessary for the concentration sensor 60 to detect the concentration is negligible as compared with the total amount of the methanol/water solution used in the power generation portion 40. The amount of the methanol/water solution flowing into the second fluid channel is significantly slight. Thus, adversely effect on fuel supply to the DMFC stack 42 can be prevented.

Incidentally, the timing to turn on or off the indicator lamp 85 and the color of the indicator lamp 85 can be changed desirably. Further, a display corresponding to the indicator lamp 85, for example, a message of normal operation, abnormal stop, etc. can be displayed on a display unit such as a display provided in the information processing apparatus 18.

### Second Embodiment

The following configuration can be made as a second embodiment.

According to the second embodiment, which is not a mode to real-time monitor and control the aforementioned supply operation quantity, a control table stored in advance is applied in accordance with a variation with time (operating time) of the fuel cell unit.

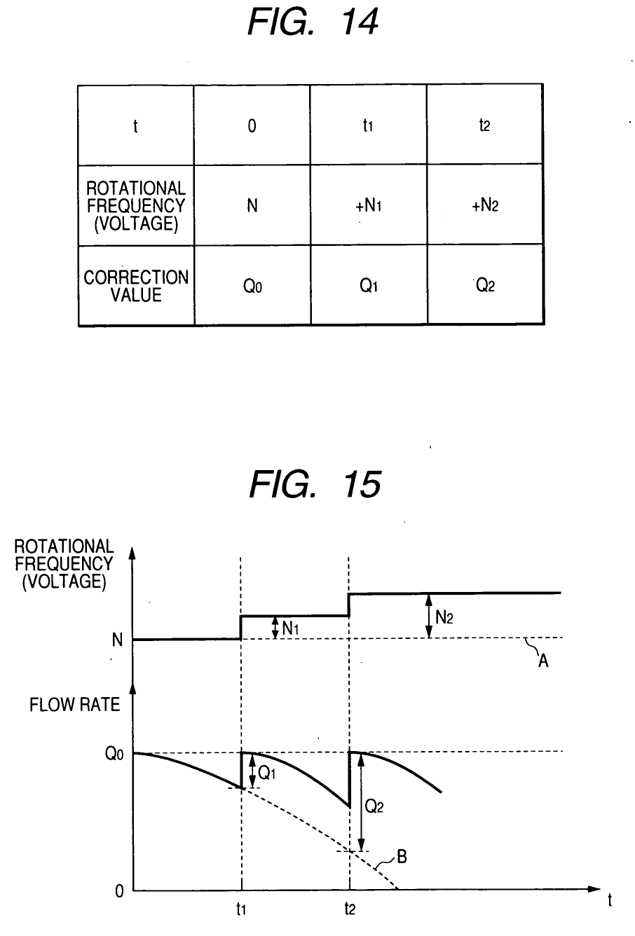

FIG. 14 is a schematic diagram showing a control table (control information) set in accordance with a variation with time of the solution feed volume information or the gas feed information. The control table is stored in the EEPROM 99 in advance.

FIG. 15 is a schematic diagram showing the transition corresponding to a variation with time of the solution feed volume information or the gas feed information, and the transition after correction. In this embodiment, description will be made on the case where the voltage (rotational frequency) of the solution feed pump 46 is changed. However, the voltage of the gas feed pump 50 may be changed, or both the voltage of the solution feed pump 46 and the voltage of the gas feed pump 50 may be changed.

The fuel cell control portion 41 reads the control table shown in FIG. 14 from the EEPROM 99, for example, when the fuel cell unit 10 is brought into the aforementioned Warm-up State ST30. At the same time, the fuel cell control portion 41 begins to measure the operating time of the fuel cell unit 10. As soon as the operating time reaches a time set in the control table read out, the fuel cell control portion 41 makes corresponding control. For example, when it is a time t₁ set in the control table, the fuel cell control portion 41 changes the voltage of the solution feed pump 46 from N to N₁ so as to increase the rotational frequency of the solution feed pump 46. Thus, the fuel cell control portion 41 makes control to increase the flow rate of the methanol/water solution (see FIG. 15). As a result of this control, the flow rate estimated to be smaller than an initial flow rate Q0 due to clogging of the filter or the like is increased by a correction value Q₁ so that the flow rate is set at the initial value Q₀ (in fact, the correction value Q₁ is an estimated value of correction at the operating time t₁, and whether the flow rate reaches the initial value Q₀ correctly or not cannot be grasped because the flow rate is not measured, but this control is aimed at restoration of the flow rate to the vicinity of the initial value Q₀).

The broken line A designates the initial value of the rotational frequency (voltage) of the solution feed pump 46, and the broken line B designates the flow rate of the methanol/water solution which is not controlled to be corrected. It is understood that the flow rate of the methanol/water solution decreases with the progress of the operating time as shown in the broken line B.

Further, for example, when it is a time t₂ set in the control table, the fuel cell control portion 41 sets the voltage of the solution feed pump 46 at N₂ so as to further increase the rotational frequency of the solution feed pump 46. Thus, the fuel cell control portion 41 makes control to increase the flow rate of the methanol/water solution. As a result of this control, the flow rate estimated to be smaller than the vicinity of the flow rate Q₀ corrected previously is increased by a correction value Q₂ with respect to the broken line B (which designates the flow rate when no control is made to correct the flow rate).

The aforementioned measurement of the operating time by the fuel cell control portion 41 may be started not in the state of Warm-up State ST30 but in a desired state, for example, in the state of On State ST40.

In such a manner, the control table stored in advance is applied to control in accordance with a variation with time (operating time} of the fuel cell unit. Thus, it is not necessary to monitor and control the supply operation quantity in real time, but it is possible to provide a fuel cell unit having a comparatively simple configuration.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A fuel cell unit comprising:
a fuel cell;
a mixing tank that mixes fuel with water obtained by condensing water vapor fed from the fuel cell, and produces a fuel/water solution to be supplied to the fuel cell;
a fuel reservoir unit that stores the fuel;
a fuel supply unit that feeds the fuel from the fuel reservoir unit to the mixing tank;
a solution feed unit that feeds the fuel/water solution from the mixing tank to the fuel cell;
a first measuring unit that is connected to the solution feed unit and measures a first supply operation quantity that is a supply operation quantity of the solution feed unit; and
a controller that comprises: a storage unit that stores a first initial value of the first supply operation quantity; and a comparison unit that compares the first supply operation quantity with the first initial value, the controller controlling one of the fuel supply unit and the solution feed unit so as that the first supply operation quantity approaches the first initial value when the comparison unit concludes that the first supply operation quantity is higher or lower than the first initial value by a predetermined value or more.

2. The fuel cell unit according to claim 1, further comprising:
a gas intake unit that draws in gas from outside;
a gas feed unit that feeds the gas drawn in by the gas intake unit to the fuel cell; and
a second measuring unit that is connected to the gas feed unit and measures a second supply operation quantity that is a supply operation quantity of the gas feed unit,
wherein the storage unit stores a second initial value of the second supply operation quantity,
wherein the comparison unit compares the second supply operation quantity with the second initial value, and
wherein the controller controls the gas feed unit so as that the second supply operation quantity approaches the second initial value when the comparison unit concludes that the second supply operation quantity is higher or lower than the second initial value by a predetermined value or more.

3. The fuel cell unit according to claim 1, further comprising a notification unit that notifies a warning information when the first supply operation quantity is higher or lower than the first initial value by a predetermined value or more.

4. The fuel cell unit according to claim 3, wherein the notification unit notifies the warning information by displaying the warning information.

5. The fuel cell unit according to claim 1, further comprising a first filter unit that is provided between the mixing tank and the solution feed unit and filters the fuel/water solution,
wherein the storage unit stores control information corresponding to variation with time of the first filter unit, and
wherein the controller performs the control based on the control information.

6. The fuel cell unit according to claim 1, wherein the first supply operation quantity is one of a driving voltage and a rotational frequency of the solution feed unit.

7. The fuel cell unit according to claim 2, wherein the first supply operation quantity is one of a driving voltage and a rotational frequency of the solution feed unit, and
wherein the second supply operation quantity is one of a driving voltage and a rotational frequency of the gas feed unit.

8. The fuel cell unit according to claim 2, further comprising a third measuring unit that measures fuel concentration of the fuel/water solution,
wherein the storage unit stores an initial value of the fuel concentration,
wherein the comparison unit compares the fuel concentration with the initial value of the fuel/water solution, and
wherein the controller controls one of the fuel supply unit and the solution feed unit so as that the fuel concentration approaches the initial value of the fuel concentration when the comparison unit concludes that the fuel concentration is higher or lower than the initial value of the fuel concentration by a predetermined value or more.

9. A fuel cell unit comprising:
a fuel cell;
a gas intake unit that draws in gas from outside;
a gas feed unit that feeds the gas drawn in by the gas intake unit to the fuel cell;
a first measuring unit that is connected to the gas feed unit and measures a first supply operation quantity that is a supply operation quantity of the gas feed unit; and
a controller that comprises: a storage unit that stores a first initial value of the first supply operation quantity; and a comparison unit that compares the first supply operation quantity with the first initial value, the controller controlling the gas feed unit so as that the first supply operation quantity approaches the first initial value when the comparison unit concludes that the first supply operation quantity is higher or lower than the first initial value by a predetermined value or more.

10. The fuel cell unit according to claim 9, further comprising:
a mixing tank that mixes fuel with water obtained by condensing water vapor fed from the fuel cell, and produces a fuel/water solution to be supplied to the fuel cell;
a fuel reservoir unit that stores the fuel;
a fuel supply unit that feeds the fuel from the fuel reservoir unit to the mixing tank;
a solution feed unit that feeds the fuel/water solution from the mixing tank to the fuel cell; and
a second measuring unit that is connected to the solution feed unit and measures a second supply operation quantity that is a supply operation quantity of the solution feed unit,
wherein the storage unit stores a second initial value of the second supply operation quantity,
wherein the comparison unit compares the second supply operation quantity with the second initial value, and
wherein the controller controls one of the fuel supply unit and the solution feed unit so as that the second supply operation quantity approaches the second initial value when the comparison unit concludes that the second supply operation quantity is higher or lower than the second initial value by a predetermined value or more.

11. The fuel cell unit according to claim 9, further comprising a notification unit that notifies a warning information when the first supply operation quantity is higher or lower than the first initial value by a predetermined value or more.

12. The fuel cell unit according to claim 11, wherein the notification unit notifies the warning information by displaying the warning information.

13. The fuel cell unit according to claim 9, further comprising a first filter unit that is provided between the gas intake unit and the gas feed unit and filters the gas,
wherein the storage unit stores control information corresponding to variation with time of the first filter unit, and
wherein the controller performs the control based on the control information.

14. The fuel cell unit according to claim 9, wherein the first supply operation quantity is one of a driving voltage and a rotational frequency of the gas feed unit.

15. The fuel cell unit according to claim 10, wherein the first supply operation quantity is one of a driving voltage and a rotational frequency of the gas feed unit, and
wherein the second supply operation quantity is one of a driving voltage and a rotational frequency of the solution feed unit.

16. The fuel cell unit according to claim 10, further comprising a third measuring unit that measures fuel concentration of the fuel/water solution,
wherein the storage unit stores an initial value of the fuel concentration,
wherein the comparison unit compares the fuel concentration with the initial value of the fuel/water solution, and
wherein the controller controls one of the fuel supply unit and the solution feed unit so as that the fuel concentration approaches the initial value of the fuel concentration when the comparison unit concludes that the fuel concentration is higher or lower than the initial value of the fuel concentration by a predetermined value or more.

17. A method for controlling a fuel cell unit including: a fuel cell; a mixing tank that mixes fuel with water obtained by condensing water vapor fed from the fuel cell, and produces a fuel/water solution to be supplied to the fuel cell; a fuel reservoir unit that stores the fuel; a fuel supply unit that feeds the fuel from the fuel reservoir unit to the mixing tank; a solution feed unit that feeds the fuel/water solution from the mixing tank to the fuel cell; a first measuring unit that is connected to the solution feed unit and measures a first supply operation quantity that is a supply operation quantity of the solution feed unit; and a controller that includes a storage unit that stores a first initial value of the first supply operation quantity, the method comprising:
comparing the first supply operation quantity with the first initial value; and
controlling one of the fuel supply unit and the solution feed unit so as that the first supply operation quantity approaches the first initial value when the first supply operation quantity is higher or lower than the first initial value by a predetermined value or more.

18. The method according to claim 17, wherein the fuel cell unit further includes: a gas intake unit that draws in gas from outside; a gas feed unit that feeds the gas drawn in by the gas intake unit to the fuel cell; and a second measuring unit that is connected to the gas feed unit and measures a second supply operation quantity that is a supply operation quantity of the gas feed unit, and
wherein the method further comprising:
storing a second initial value of the second supply operation quantity;
comparing the second supply operation quantity with the second initial value; and
controlling the gas feed unit so as that the second supply operation quantity approaches the second initial value when the second supply operation quantity is higher or lower than the second initial value by a predetermined value or more.

19. A method for controlling a fuel cell unit including: a fuel cell; a gas intake unit that draws in gas from outside; a gas feed unit that feeds the gas drawn in by the gas intake unit to the fuel cell; a first measuring unit that is connected to the gas feed unit and measures a first supply operation quantity that is a supply operation quantity of the gas feed unit; a controller that includes a storage unit that stores a first initial value of the first supply operation quantity, the method comprising:
comparing the first supply operation quantity with the first initial value; and
controlling the gas feed unit so as that the first supply operation quantity approaches the first initial value when the first supply operation quantity is higher or lower than the first initial value by a predetermined value or more.

20. The method according to claim 19, wherein the fuel cell unit further includes: a mixing tank that mixes fuel with water obtained by condensing water vapor fed from the fuel cell, and produces a fuel/water solution to be supplied to the fuel cell; a fuel reservoir unit that stores the fuel; a fuel supply unit that feeds the fuel from the fuel reservoir unit to the mixing tank; a solution feed unit that feeds the fuel/water solution from the mixing tank to the fuel cell; and a second measuring unit that is connected to the solution feed unit and measures a second supply operation quantity that is a supply operation quantity of the solution feed unit, and
wherein the method further comprising:
storing a second initial value of the second supply operation quantity;
comparing the second supply operation quantity with the second initial value; and
controlling one of the fuel supply unit and the solution feed unit so as that the second supply operation quantity approaches the second initial value when the second supply operation quantity is higher or lower than the second initial value by a predetermined value or more.
